(19) United States
(12) Patent Application Publication
(10) Pub. No.: US 2009/0096318 A1
(43) Pub. Date: Apr. 16, 2009

(54) METHOD AND APPARTUS FOR GENERATING ELECTRICITY

(75) Inventors: James Peter Metropoulos, Manhattan Beach, CA (US); Oscar Casillas, Chula Vista, CA (US)

Correspondence Address: PATENT INGENUITY, PC, 520 BROADWAY, SUITE 350, SANTA MONICA, CA, 90401, US

(73) Assignee: James Peter Metropoulos, Manhattan Beach, CA (US)

(21) Appl. No.: 11/871,141

(22) Filed: Oct. 11, 2007

(51) Int. Cl. H02N 11/00

(52) U.S. Cl. 310/300

(57) ABSTRACT

An apparatus includes a silica container that contains a plurality of silica particles such that a first subgroup of the plurality of silica particles is located within a first chamber of the silica container and a second subgroup of the plurality of silica particles is located within a second chamber of the silica container. The first chamber receives a negative electrical current and the second chamber receiving a positive electrical current. Further, the apparatus includes a plurality of magnets. Each of the plurality of magnets receives an electrical current. In addition, the plurality of magnets is arranged to surround the silica container so that a magnetic field exerts a force on at least one of the silica particles to remove an electron from the silica particle to cause the silica particle to replace the removed electron by absorbing an electron from the atmosphere.

### BACKGROUND

1. Field

This disclosure generally relates to the field of electricity. More particularly, the disclosure relates to generating electricity with a magnetic field.

2. General Background

A typical electrical power plant utilizes a turbine that can be powered by a variety of different energy sources. The turbine is connected to a shaft that is wrapped in a series of conductive coils, e.g., copper. Further, the shaft and coils are surrounded by a powerful magnet that creates a magnetic field. The turbine causes the shaft, and thereby the conductive coils, to rotate within the magnetic field created by the magnet. As a result, electricity is generated and transmitted through transmission lines to destinations such as consumer homes.

Other approaches have been developed to generate electricity. For example, fuel cells utilize a chemical reaction involving hydrogen and oxygen to produce electricity. Further, solar panels utilize photovoltaic cells to produce electricity from a reaction caused by receiving a photon.

These current approaches to generating electricity are, for the most part, inefficient. Irrespective of the type of energy source, e.g., coal, oil, gas, solar, or wind, that is utilized to produce electricity, a loss normally occurs during the conversion from energy produced by one of these power sources to electricity. Given the limited supplies and/or expense of current energy sources, the lack of conversion efficiency is leading to increased electricity costs for the consumer.

### SUMMARY

In one aspect of the disclosure, an apparatus is provided. The apparatus includes a silica container that contains a plurality of silica particles such that a first subgroup of the plurality of silica particles is located within a first chamber of the silica container and a second subgroup of the plurality of silica particles is located within a second chamber of the silica container. The first chamber receives a negative electrical current and the second chamber receiving a positive electrical current. Further, the apparatus includes a plurality of magnets. Each of the plurality of magnets receives an electrical current. In addition, the plurality of magnets is arranged to surround the silica container so that a magnetic field exerts a force on at least one of the silica particles to remove an electron from the silica particle to cause the silica particle to replace the removed electron by absorbing an electron from the atmosphere.

In another aspect of the disclosure, a method is utilized. The method provides a first electrical current to a plurality of silica particles. Further, the method provides a second electrical current to a plurality of magnets to establish a magnetic field. In addition, the method positions the plurality of silica particles in the magnetic field so that the magnetic field exerts a force on at least one of the silica particles to remove an electron from the silica particle to cause the silica particle to replace the removed electron by absorbing an electron from the atmosphere.

In yet another aspect of the disclosure, another method is utilized. The method provides a first electrical current to a first subgroup of a plurality of silica particles positioned in a first chamber of a silica container and a second electrical current to a second subgroup of a plurality of silica particles positioned in a second chamber of the silica container. Further, the method provides an electrical current to a plurality of magnets to establish a magnetic field. In addition, the method positions the silica container in the magnetic field so that the magnetic field exerts a force on at least one of the silica particles to remove an electron from the silica particle to cause the silica particle to replace the removed electron by absorbing an electron from the atmosphere.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1 illustrates a top view of a silica cell that contains a plurality of silica cell particles.

FIG. 2 illustrates a top view of an electromagnet configuration.

FIG. 3 illustrates a top view of a fitted electromagnet configuration utilizing the magnets shown in FIG. 2.

FIG. 4 illustrates a top view of an electromagnet configuration that is utilized to generate electricity.

FIG. 5 illustrates a process that may be utilized to generate electricity.

FIG. 6 illustrates an alternative embodiment of an apparatus that generates electricity.

### DETAILED DESCRIPTION

A method and apparatus are disclosed that provide for generating electricity. Irrespective of the power source, e.g., fossil fuels, solar, wind, etc., a relatively small amount of energy can be enhanced to yield a relatively large amount of energy. The method and apparatus generate electricity by separating electrons from silica particles and then allowing the silica particles to absorb new free floating electrons from the atmosphere to create a sizeable electrical current.

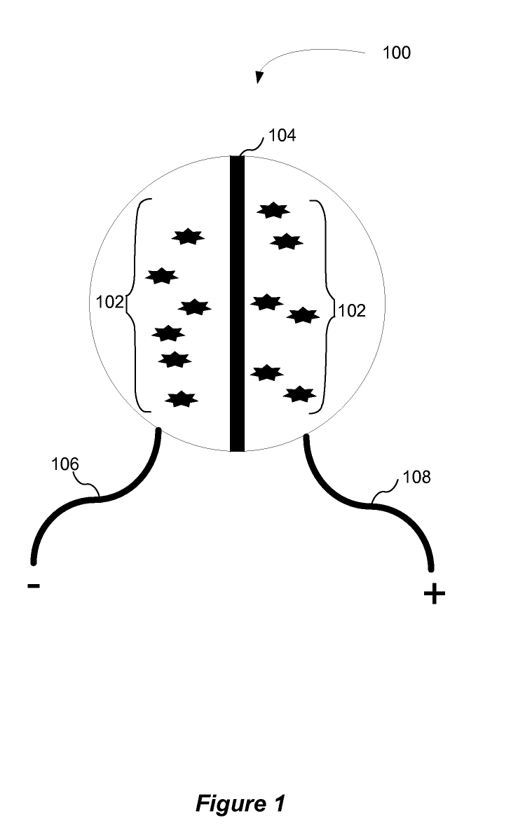

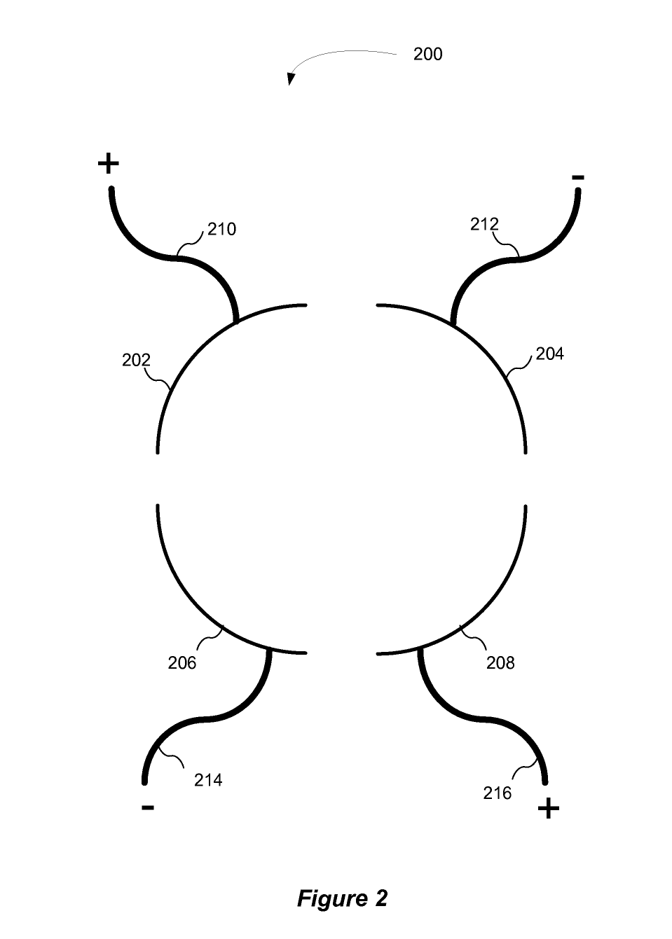

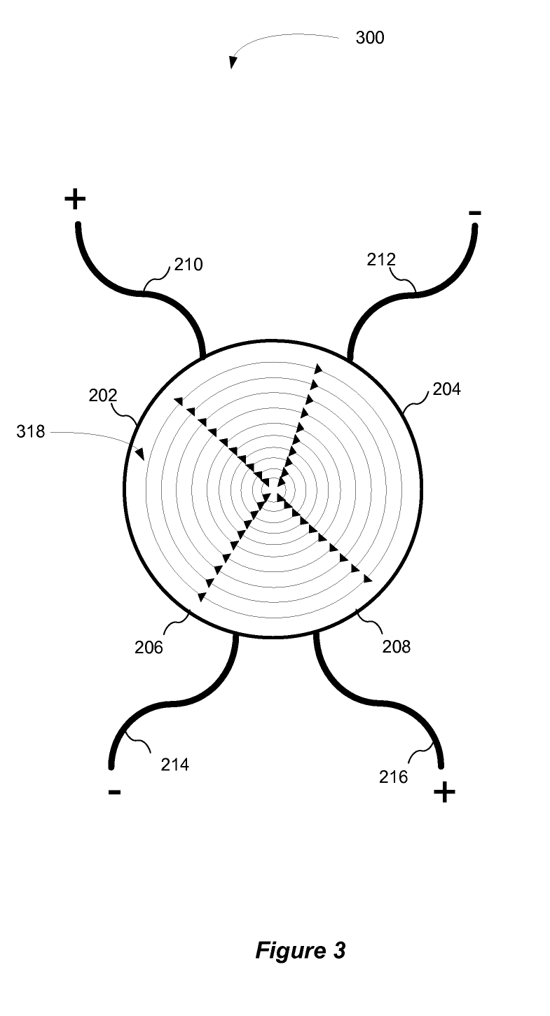

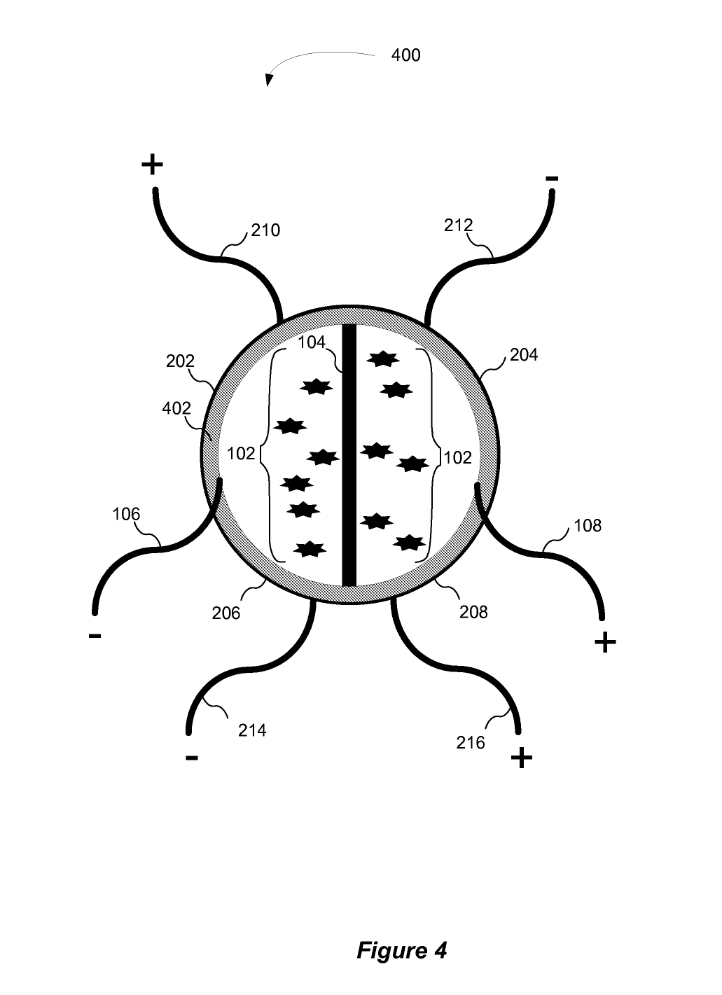

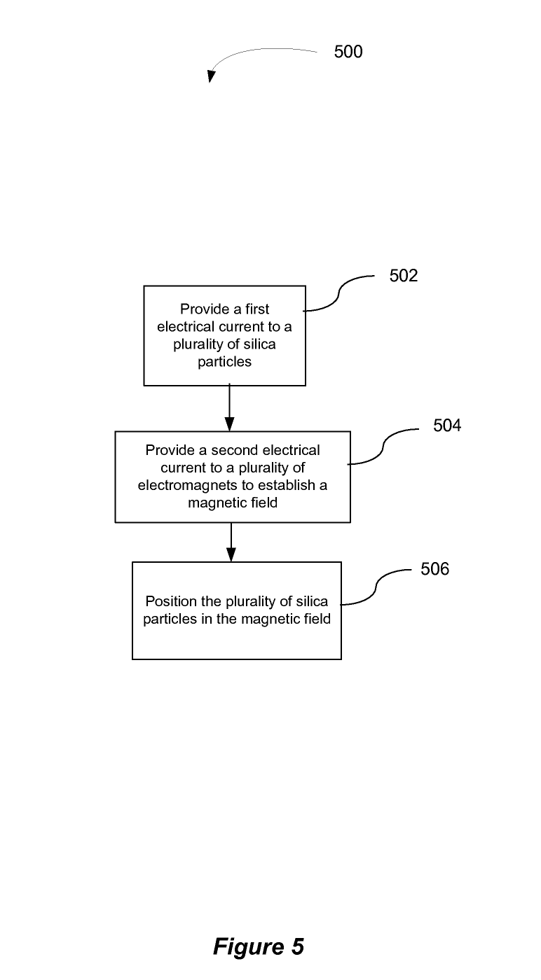

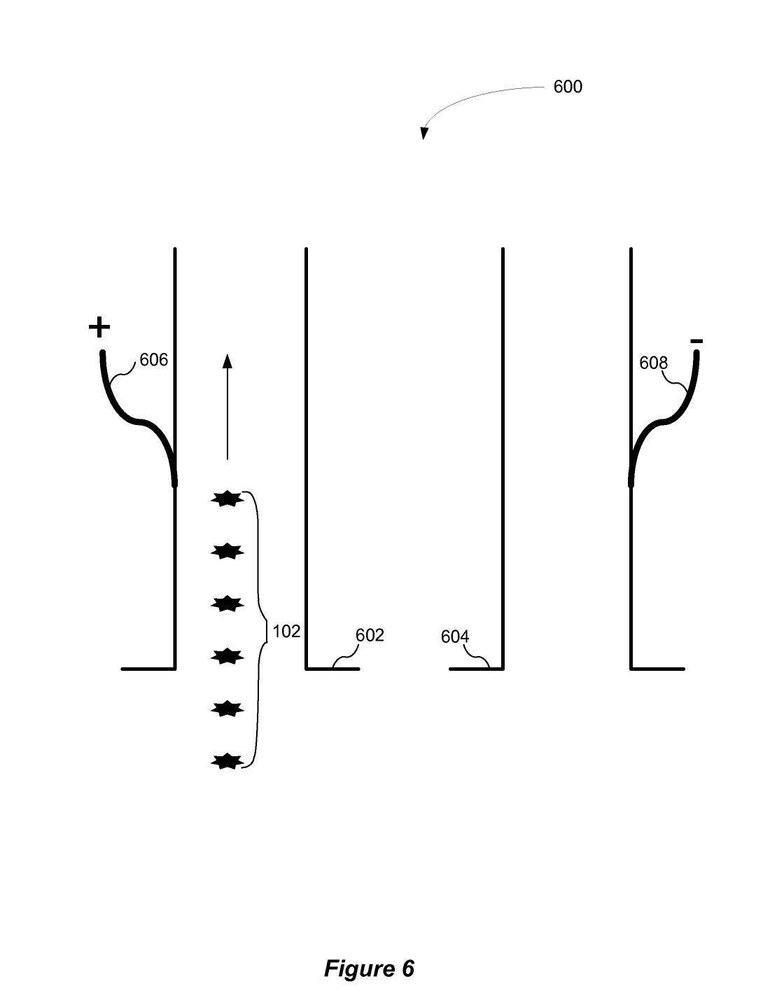

As will be discussed, FIG. 1 illustrates a silica cell 100, FIGS. 2 and 3 illustrate a plurality of magnets, and FIG. 4 illustrates how the silica cell 100 is utilized in conjunction with the plurality of magnets to generate electricity. Further, FIG. 5 illustrates a process 500 that can be utilized to generate electricity. Finally, FIG. 6 illustrates an alternative apparatus 600 that may be utilized to generate electricity.

FIG. 1 illustrates a top view of a silica cell 100 that contains a plurality of silica cell particles 102. The plurality of silica cell particles is statically positioned within the silica cell 100. In one embodiment, each of the silica cell particles is of an equal size in dimensions. In another embodiment, each of the silica cell particles is of a substantially similar size within a small order of magnitude. In yet another embodiment, the silica particles are pure silica. In an alternative embodiment, the silica particles are composite particles that include a combination of silica and at least one other material.

The plurality of silica particles 102 is separated into two compartments in the silica cell 100. A nonconductive separator 104 divides the silica cell 100 into the two compartments and separates the two different sub-groups of the plurality of silica particles 102. In one embodiment, the sub-groups are formed so that approximately half of the plurality of silica particles 102 is in one compartment while approximately half of the plurality of silica particles 102 is in the other compartment. Alternatively, a greater portion of the plurality of silica particles 102 can be positioned in one of the compartments while a lesser portion of the plurality of silica particles 102 can be positioned in the other compartment.

Further, a negatively charged wire 106 is operably connected to one of the compartments of the silica cell 100 while a positively charged wire 108 is operably connected to the other compartment of the silica cell 100. As a result the silica cell has a first compartment with negatively charged silica particles and a second compartment with positively charged silica particles. Therefore, the plurality of silica particles 102 becomes a conductor of electrical current.

FIG. 2 illustrates a top view of an electromagnet configuration 200. In one embodiment, the electromagnet configuration includes a plurality of magnets. For example, the electromagnet configuration 200 may include four magnets: a first magnet 202, a second magnet 204, a third magnet 206, and a magnet electromagnet 208. Further, each of the magnets is operably connected to a wire with current. For instance, the first magnet 202 is operably connected to a positively charged wire 210, the second magnet 204 is operably connected to a negatively charged wire 212, the third magnet 206 is operably connected to a positively charged wire 214, and the fourth magnet 208 is operably connected to a negatively charged wire 216. Each of the magnets can have an arc shape so that it can be fitted together with the other magnets.

The number of magnets illustrated in FIG. 2 is provided as an example. More or less magnets can potentially be utilized. Further, the shape of the magnets illustrated in FIG. 2 is provided as an example. Various shapes may be utilized to fit the magnets with one another.

FIG. 3 illustrates a top view of a fitted electromagnet configuration 300 utilizing the magnets shown in FIG. 2. When the first magnet 202, the second magnet 204, the third magnet 206, and the fourth magnet 208 are fitted next to one another to form a circular configuration and the respective currents are applied, a magnetic field 318 is formed within that circular configuration. The magnetic field 318 creates a pulling force.

FIG. 4 illustrates a top view of an electromagnet configuration 400 that is utilized to generate electricity. In one embodiment, the electromagnet configuration 400 is formed by positioning the silica cell 100 shown in FIG. 1 within the magnetic field 318 of the fitted electromagnet configuration 300. As a result, the electromagnet configuration 400 utilizes the pulling force of the magnetic field 318 to separate electrons from the silica particles so that the plurality of silica particles 102 in the silica cell 100 absorb new electrons from the atmosphere to generate a sizeable current. Further, the electrical charges provided to the silica cell, i.e., through the negatively charged wire 106 and the positively charged wire 108, enhance the conductivity of the silica particles to assist the magnetic field 318 in loosening the electrons from the silica particles.

The silica particle includes a covalent bond of electrons. Once an electron is stripped from a silica particle, the silica particle immediately grabs a floating electron from the surrounding atmosphere in order to restore the covalent bond. As the plurality of silica particles 102 remains within the magnetic field 318, numerous electrons are removed and replaced by electrons from the atmosphere. In one embodiment, the electrons that removed are gathered on a collector component 402. The collector component 402 is made from a highly conductive material, e.g., copper or zinc. Further, the collector component 402 is positioned between the fitted electromagnet configuration 300 and the silica cell 100. A large amount of electrical charge can be gathered on the collector component 402 for transfer to a destination that can utilize the electricity. For example, the electricity that is generated can be utilized by a power plant, a home, a mode of transportation, an appliance, etc. Examples of the mode of transportation include hybrid or electric automobiles, trains, ships, airplanes, and the like. Further, examples of the appliance include, computers, televisions, refrigerators, and the like. In one embodiment, the method and apparatus can be utilized to generate electricity in a more decentralized manner than seen in current approaches. For example, at a location such as a house, an office building, or a factory, a relatively small amount of electricity can be pulled from a power grid, and the remaining requisite amount of electricity can be generated onsite by utilizing the method and apparatus in conjunction with the relatively small amount of electricity obtained form the power grid. Alternatively, any electrically conductive pathway may be utilized in place of the collector component 402.

This process of having the magnetic field 318 pull an electron from a silica particle and replacing that electron with one from the atmosphere is repeated by having the magnetic field 318 pull the newly replaced electron from the atmosphere with another electron from the atmosphere. Accordingly, as the power of the magnetic field 318 is increased, i.e., by increasing the current in the charged wires operably connected to the plurality of magnets to increase the frequency, more electrons are removed from the silica particle and replaced with particles from the atmosphere in a shorter period of time. Further, as the volume of silica particles positioned in the silica cell 100 is increased, more electrons are also removed from the silica particle and replaced with particles from the atmosphere in a shorter period of time. A greater number of removed electrons lead to more electrons gathered on the collector component 402, which thereby leads to the generation of more electricity.

Further, in one embodiment, a ratio can be maintained between the current of the charged wires operably connected to the fitted electromagnet configuration 300 and the current of the charged wires operably connected to the silica cell 100. For example, a ratio of approximately ten to one can be utilized. In other words, the frequency for the charged wires operably connected to the fitted electromagnet configuration 300 is in a constant proportion greater than the frequency of the charged wires operably connected to the silica cell 100. The ratio helps ensure the stability of the process. Other ratios may be utilized so long as the charged wires operably connected to the fitted electromagnet configuration provide substantially more current than the charged wires operably connected to the silica cell 100.

As opposed to the loss in energy conversion seen in current approaches, the method and apparatus of the disclosure actually enhance the energy that is received as an input. For instance, experiments have shown that providing a total current of approximately one Amp through the charged wires operably connected to the plurality of magnets and a total current of approximately one tenth of one Amp through the charged wires operably connected to the silica cell 100 results in generating approximately thirty Amps of electricity. Therefore, the amount of electricity generated from an energy source can be multiplied. As a result, even energy sources that have a limited supply can be much more efficiently utilized.

The example apparatus illustrated can be operably connected to an appliance to generate electricity that powers the appliance. For example, the apparatus can be connected internally or externally to the appliance. Further, the example apparatus can be implemented in larger contexts. For instance, a plurality of large magnets and a large silica cell containing a large number of silica particles can be utilized in a power plant to generate electricity that is provided for home consumption. Accordingly, the example apparatus can be modified to accommodate varying electricity needs.

FIG. 5 illustrates a process 500 that may be utilized to generate electricity. At a process block 502, the process 500 provides a first electrical current to a plurality of silica particles. Further, at a process block 504, the process 500 provides a second electrical current to a plurality of magnets to establish a magnetic field. Finally, at a process block 506, the process 500 positions the plurality of silica particles in the magnetic field. As a result, the magnetic field exerts a force on at least one of the silica particles to remove an electron from the silica particle to cause the silica particle to replace the removed electron by absorbing an electron from the atmosphere. In one embodiment, the process 500 maintains the position of the plurality of silica particles in the magnetic field so that the magnetic field subsequently exerts a force on the silica particle to remove the electron absorbed from the atmosphere from the silica particle. The process 500 can maintain the position of the plurality of silica particles until the repeating of the removal replaced electrons yields a desired amount of electricity.

FIG. 6 illustrates an alternative embodiment of an apparatus that generates electricity. In one embodiment, the plurality of silica particles 102 does not have to be static. For example, the plurality of silica particles can be fluidized. Further, the fluidized silica particles can be sent through a plurality of electromagnetic towers. For example, the fluidized silica particles can be sent through a first tower 602 that includes one or more magnets. The first tower 602 is operably connected to a positively charged wire 606. Further, the fluidized silica particles can then be sent through a second tower 604 that includes one or more magnets. The second tower 604 is operably connected to a negatively charged wire 608. In one embodiment, the towers are made of conductive material such as copper. During the circulation of the fluidized silica particles through the towers, the electrons are pulled from the fluidized silica particles by the magnetic field created by the magnets in the first tower 602 and the second tower 604. Further, the pulled electrons are replaced by the electrons from the atmosphere. As the fluidized silica particles are re-circulated through the towers, the newly added electrons are pulled by the electromagnetic field and replaced by electrons from the atmosphere. The process can be repeated until the amount of desired electricity is generated.

Silica particles are described in this disclosure as an example of particles that can be utilized with the method and apparatus to generate electricity. However, other suitable particles may also be utilized.

It is understood that the method and apparatus described herein may also be applied in other types of systems. Those skilled in the art will appreciate that the various adaptations and modifications of the embodiments of this method and apparatus may be configured without departing from the scope and spirit of the present method and system. Therefore, it is to be understood that, within the scope of the appended claims, the present method and apparatus may be practiced other than as specifically described herein.

I claim:

1. An apparatus comprising:
a silica container that contains a plurality of silica particles such that a first subgroup of the plurality of silica particles is located within a first chamber of the silica container and a second subgroup of the plurality of silica particles is located within a second chamber of the silica container, the first chamber receiving a negative electrical current and the second chamber receiving a positive electrical current; and
a plurality of magnets, each of which receives an electrical current, arranged to surround the silica container so that a magnetic field exerts a force on at least one of the silica particles to remove an electron from the silica particle to cause the silica particle to replace the removed electron by absorbing an electron from the atmosphere.

2. The apparatus of claim 1, further comprising a collector component that receives the removed electron to provide electricity.

3. The apparatus of claim 1, wherein the magnetic field subsequently exerts a force on the silica particle to remove the electron absorbed from the atmosphere from the silica particle.

4. The apparatus of claim 3, further comprising a collector component that receives the removed electron and the electron absorbed from the atmosphere that is removed to provide electricity.

5. The apparatus of claim 1, wherein a ratio of a total current received by the plurality of magnets to a total current received by the silica container is maintained.

6. The apparatus of claim 5, wherein the ratio is maintained such that the total current received by the plurality of magnets is larger than the total current received by the silica container.

7. The apparatus of claim 1, wherein the first chamber and the second chamber are separated by a nonconductive separator.

8. The apparatus of claim 1, wherein each of the magnets has an arc shape.

9. The apparatus of claim 1, wherein the plurality of magnets are arranged to form a circular configuration.

10. The apparatus of claim 1, wherein the plurality of magnets a first magnet, a second magnet, a third magnet, and a fourth magnet.

11. The apparatus of claim 10, wherein the first magnet receives a positive electrical current, the second magnet receives a negative electrical current, the third magnet receives a negative electrical current, and the fourth magnet receives a positive electrical current.

12. A method comprising:
providing a first electrical current to a plurality of silica particles;
providing a second electrical current to a plurality of magnets to establish a magnetic field; and
positioning the plurality of silica particles in the magnetic field so that the magnetic field exerts a force on at least one of the silica particles to remove an electron from the silica particle to cause the silica particle to replace the removed electron by absorbing an electron from the atmosphere.

13. The method of claim 12, further comprising generating electricity by providing the removed electron.

14. The method of claim 12, further comprising maintaining the position of the plurality of silica particles in the magnetic field so that the magnetic field subsequently exerts a force on the silica particle to remove the electron absorbed from the atmosphere from the silica particle.

15. The method of claim 12, further comprising generating electricity by providing the removed electron and the electron absorbed from the atmosphere that is removed.

16. A method comprising:
providing a first electrical current to a first subgroup of a plurality of silica particles positioned in first chamber of a silica container and a second electrical current to a second subgroup of a plurality of silica particles positioned in a second chamber of the silica container;
providing an electrical current to a plurality of magnets to establish a magnetic field; and
positioning the silica container in the magnetic field so that the magnetic field exerts a force on at least one of the silica particles to remove an electron from the silica particle to cause the silica particle to replace the removed electron by absorbing an electron from the atmosphere.

17. The method of claim 16, wherein a ratio of a total current received by the plurality of magnets to a total current received by the silica container is maintained.

18. The method of claim 17, wherein the ratio is maintained such that the total current received by the plurality of magnets is larger than the total current received by the silica container.

19. The method of claim 16, wherein the first chamber and the second chamber are separated by a nonconductive separator.

20. The method of claim 16, wherein the plurality of magnets are arranged to form a circular configuration.
